(19) United States
(12) Patent Application Publication
(10) Pub. No.: US 2008/0273151 A1
(43) Pub. Date: Nov. 6, 2008

(54) LOW COLOR SHIFT OPTICAL FILM AND LIQUID CRYSTAL DISPLAY CONTAINING THE SAME

(75) Inventors: Hui-Lung Kuo, Taipei City (TW); Mei-Chih Peng, Taoyuan County (TW)

Correspondence Address: QUINTERO LAW OFFICE, PC, 2210 MAIN STREET, SUITE 200, SANTA MONICA, CA, 90405, US

(73) Assignee: INDUSTRIAL TECHNOLOGY RESEARCH INSTITUTE, Hsinchu (TW)

(21) Appl. No.: 12/113,905

(22) Filed: May 1, 2008

(30) Foreign Application Priority Data
May 4, 2007 (TW) TW96115861

(51) Int. Cl. G02F 1/1335

(52) U.S. Cl. 349/115; 349/117

(57) ABSTRACT

A low color shift optical film is provided. The low color shift optical film comprises a cholesteric liquid crystal film and a retardation plate consisting of one or more O-plate type retardation plates on the cholesteric liquid crystal film. The retardation plate provides functions of polarization transformation and color shift compensation.

### CROSS REFERENCE TO RELATED APPILCATIONS

This Application claims priority of Taiwan Patent Application No. 96115861, filed on May 4, 2007, the entirety of which is incorporated by reference herein.

### BACKGROUND OF THE INVENTION

1. Field of the Invention

The invention relates to optical components, and more particularly to a lower color shift optical film and a liquid crystal display containing the same.

2. Description of the Related Art

Liquid crystal displays (LCD) are not self-emitting and usually required a light-emitting backlight module as a light source. Under a polarized light system, multi-components mixture of liquid crystals in the LCD functions like a light valve when applied an electric field on it. That's why a LCD can display vivid images or motion pictures. Said polarized light system is usually built with a pair of polarizers.

Conventional polarizers are formed of dichroic materials containing iodine ion complexes or dichroic dyes. This kind of polarizers has significant different light absorption behaviors at two perpendicular axes, i.e., the highest absorbency along one axis (absorbent axis) and the lowest absorbency along another axis (transmission axis) perpendicular to the absorbent axis. Usually, this kind of polarizers absorbs more than one half of the incident light, causing low utilizing efficiency of transmitting light energy. Conventional polarizers cannot fully satisfy requirements of high brightness and low power consumption for liquid crystal displays.

Currently, methods are applied for improving the utilization of light energy of the LCD. One way to increase efficiency of light utilization of LCDs is transform the light vibrating at the absorbent axis of a polarizer into the light vibrating at the transmission axis of the polarizer by way of the reflection and light recovery mechanism of the backlight module.

Cholesteric liquid crystal film can be a reflective polarizer. The cholesteric liquid crystal film is able to separate natural light into left-circular polarized light and right-circular polarized light depending upon the helix handness of the film. The circular polarized light with same stacked helicity (i.e., chirality) of the cholesteric liquid crystal molecules is reflected by the cholesteric liquid crystal film, while the other circular polarized light with reverse stacked helicity of the cholesteric liquid crystal layers passes through the cholesteric liquid crystal film. When cholesteric liquid crystal film is disposed on the light-outgoing face of a backlight module of the liquid crystal display, it will enhance the light efficiency of the transmissive type LCD via the light recycling mechanism of the backlight module.

Nowadays, liquid crystal displays are generally designed for linear polarized light. Thus, the circular polarized light obtained from the above cholesteric liquid crystal film needs to be transformed into linear polarized light for applying in most of LCDs. Theoretically, the transformation requires a quarter wave film (QWF) disposed on the cholesteric liquid crystal film. The polarization transformation is achieved by adjusting the angle between the axes of the quarter wave film and the polarizer. The combination of the quarter wave film and the cholesteric liquid crystal film discribed above together with a backlight module can achieve high utilization of light energy of a display panel, enhancing the brightness of a display.

However, the conventional quarter wave film is usually A-plate type. Referring to FIG. 1, an A-plate type quarter wave film has a common optical axis 14 parallel to the plane of the quarter wave film body. A combination of an A-plate type quarter wave film and the cholesteric liquid crystal film makes the liquid crystal display show different colors at large viewing angles, i.e., the color shift. Serious color shift degrades the display quality of a color display. Therefore, an optical film with integrated functions to improve color shift, transform polarization state and enhance brightness of color displays is desired.

Several methods are provided to improve color shift and enhance brightness of displays. U.S. Pat. No. 5,731,886 discloses a positive C-plate compensation film disposed on the quarter wave film to compensate for color shift in displays. Nevertheless, seldom material can be applied for this solution. Besides, it is hardly to mass produce a positive C-plate compensation film with big dimension and high uniformity at the same time.

An O-plate film is an optical compensation film with a representative optical axis at a tilt angle neither perpendicular nor parallel to the normal of the O-plate film. There are two types of O-plate, classified by the distribution of the optical axes. In a splay-type O-plate film, the angle between each optical axis and the surface plane from the top face to the bottom face of the film, continuously changes. In a syn-clinic-type O-plate film, all the optical axes, from the top face to the bottom face of the film, have a common angle in view of the surface plane of the O-plate.

An O-plate film can be used in a twisted nematic (TN) or a super twisted nematic (STN) liquid crystal display as a viewing angle and contrast compensation film, for example, as disclosed in U.S. Pat. No. 5,504,603 and 7,088,411.

### BRIEF SUMMARY OF THE INVENTION

The invention provides a low color shift optical film comprising a cholesteric liquid crystal film and a retardation plate consisting of one or more O-plate films on the cholesteric liquid crystal film, and the retardation plate provides functions of polarization transformation and color shift compensation.

The retardation plate consisting of one or more O-plate films according to the invention can serve as a quarter wave film, and transforms a circular polarized light passing through the cholesteric liquid crystal film into a linear polarized light. The retardation plate not only can serve as a quarter wave film, but also can reduce color shift at large viewing angles due to the cholesteric liquid crystal film's natural. Therefore, the retardation plate according to the invention is an integrated optical film with functions of the quarter wave film as well as a color shift compensation film. Moreover, O-plate films can also be stacked in manners of symmetrical optical axis or asymmetrical optical axis, depend on the viewer's requirement.

The invention further provides a liquid crystal display comprising a liquid crystal cell and a pair of top and bottom polarizers oppositely disposed, sandwiching the liquid crystal cell. A backlight source is disposed under the bottom polarizer. The low color shift optical film of this invention is disposed between the backlight source and the bottom polarizer, wherein the cholesteric liquid crystal film side of the low color shift optical film faces the backlight source. The liquid crystal display of this invention shows bottom power consumption than traditional LCD, which has not the film of this invention.

In addition, this invention further provides a low color shift polarized light source comprising a backlight module and the low color shift optical film of this invention disposed over a light emitting surface of the backlight module.

The invention further provides a method for polarization transformation and color shift compensation for a liquid crystal display. The method comprises a liquid crystal cell and a pair of polarizers oppositely disposed to sandwich the liquid crystal cell. A backlight source is dispose under the bottom polarizer. The low color shift optical film of this invention is disposed between the backlight source and the lower polarizer, wherein the cholesteric liquid crystal film side of the low color shift optical film faces the backlight source.

A detailed description is given in the following embodiments with reference to the accompanying drawings.

### BRIEF DESCRIPTION OF THE DRAWINGS

The invention can be more fully understood by reading the subsequent detailed description and examples with reference to the accompanying drawings, wherein:

FIG. 1 is a cross section showing optical axes of an A-plate quarter wave film;

FIGS. 2A and 2B are cross sections showing optical axes of O-plate films;

FIGS. 3A and 3B are cross sections of optical films according to embodiments of the invention, wherein one O-plate film is disposed on a cholesteric liquid crystal film;

FIGS. 3C to 3J are cross sections of optical films according to embodiments of the invention, wherein two O-plate films are disposed on a cholesteric liquid crystal film;

FIG. 4 is a cross section of a liquid crystal display of an embodiment of the invention;

FIG. 5A shows color shift values of optical film of Example 1 at various viewing angles;

FIG. 5B shows color shift values of an optical film of Comparative Example 1 at various viewing angles; and

FIG. 6 shows a schematic view of a retardation plate having three dimensions of x, y, z and a thickness of d.

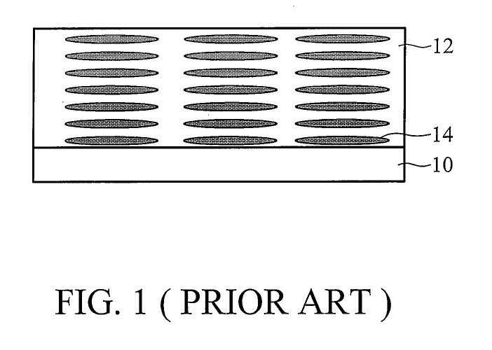

### DETAILED DESCRIPTION OF THE INVENTION

The following description is of the best-contemplated mode of carrying out the invention. The description is provided for illustrating the general principles of the invention and is not meant to be limiting. The scope of the invention is best determined by reference to the appended claims.

An embodiment of the invention provides an optical component comprising a retardation plate consisting of one or more O-plate films for serving as a quarter wave film disposed on a cholesteric liquid crystal film. The optical component can be combined with a backlight source to provide a low-color-shift and polarized light source for a liquid crystal display. One or more O-plate films are used as an element of the quarter wave film. The resulted retardation plate can not only serve as a quarter wave film for polarization transformation but also reduce color shift at large viewing angles. Therefore, the optical component of the invention can be used in liquid crystal displays to achieve a simplified structure with high brightness and low color shift at large viewing angles.

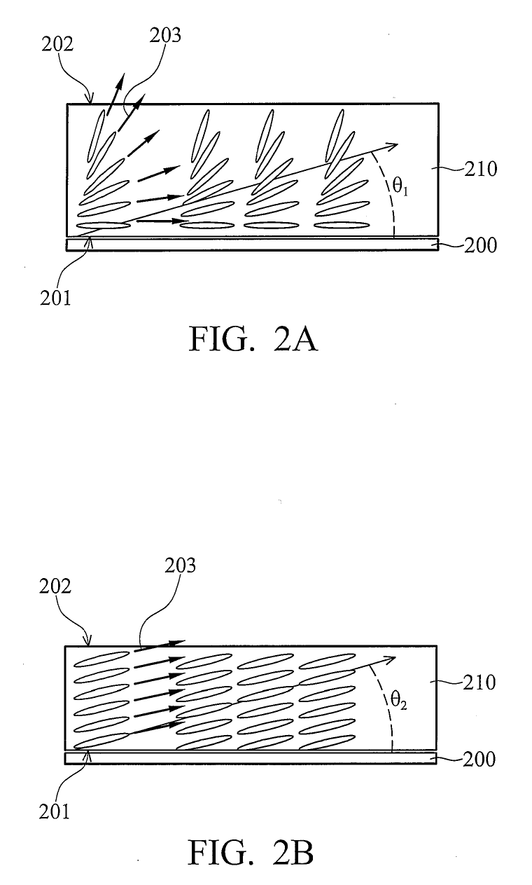

Referring to FIGS. 2A and 2B, each O-plate film 210 is an optical film with an representative optical axe tilted at an angle (θ₁ in FIG. 2A and θ₂ in FIG. 2B) to the film surface plane. The material of the O-plate film may be a nematic or a discotic liquid crystal, which can be formed on a substrate 200. The material of the substrate can be a release film, which is removed after the formation of the optical component according to the invention. The O-plate film has a top surface 201 and a bottom surface 202. There are two types of the O-plate; one is splay type as exemplified in FIG. 2A, and the other is syn-clinic type as exemplified in FIG. 2B. In the splay type O-plate, the angle of each optical axis continuously changes from a substantially horizontal state (i.e., 0 degrees) to a substantially vertical state (i.e., 90 degrees) from the bottom to top of the film. The splay type O-plate film has an approximate average tilt angle θ₁ representing the average angle of all angles of optical axes. In the synclinic type O-plate, the optical axes have substantially the same tilt angles θ₂ (>0) from bottom to top of the film, i.e., and the optical axes of the molecules from the bottom to top are titled at same angle with respect to the film plane.

One O-plate type film can be used to be a retardation plate according to embodiments of the invention. The retardation plate can be combined with a cholesteric liquid crystal film to form said low-color-shift optical film of this invention, wherein the retardation plate has an in-plane retardation Ro of 130±30 nm,

where Ro=[nx−ny]·d

nx, ny are the refractive indexes of the retardation plate on the plane, and nx is the biggest value of the refractive index within the plane of the retardation plate and ny is the refractive index on the axis perpendicular to nx,

and an out-of-plane retardation Rth≧90 nm, where Rth is defined as following equation:

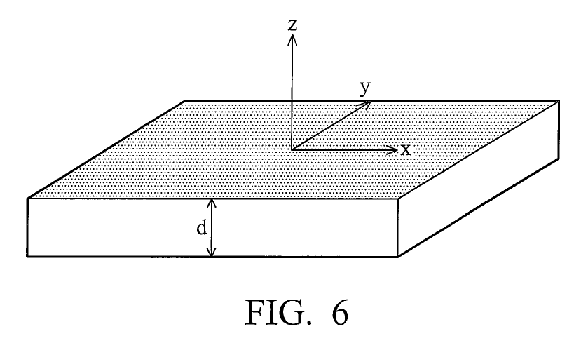

Rth=d·[nz−(nx+ny)/2]

where d in the equation is the thickness of the retardation plate, and nx, ny, nz represent the refractive indexes in the three dimensions of the retardation plate, especially, nz represents the refractive index of the retardation plate on the axis perpendicular to the retardation plate's surface, as shown in FIG. 6.

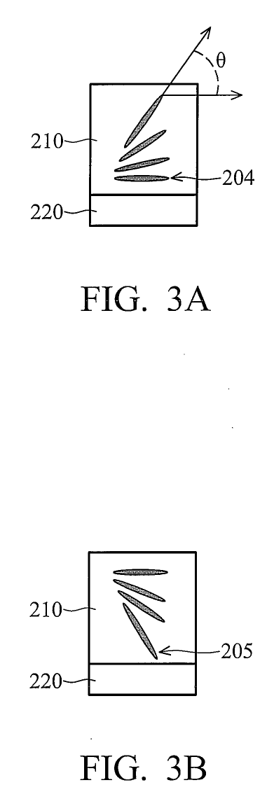

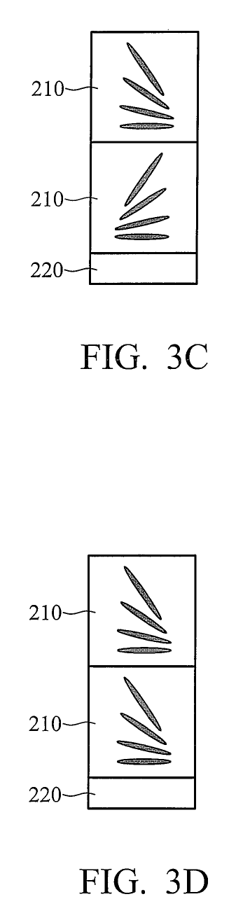

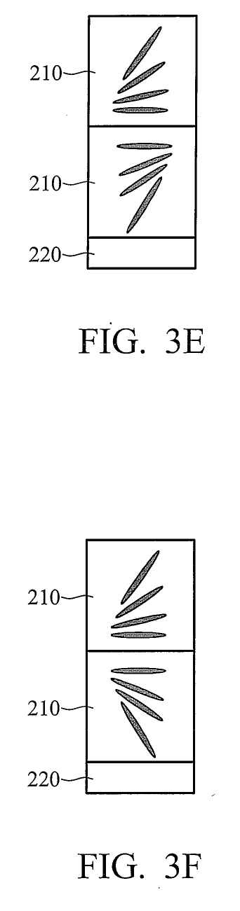

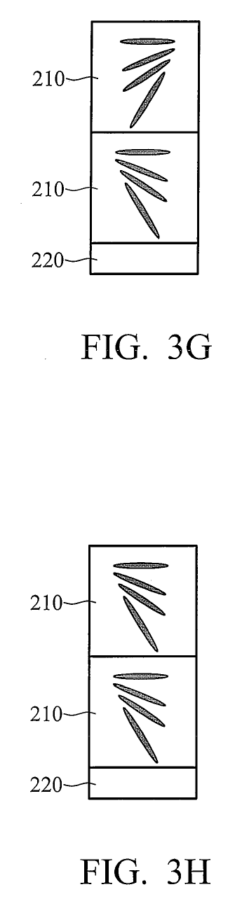

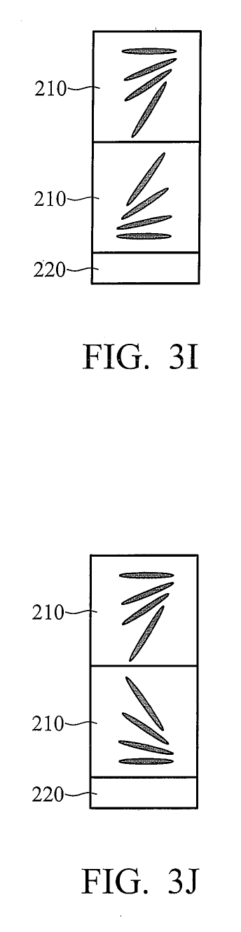

The average tilted optical axis of one single O-plate type film of the retardation plate is >0 degree and ≦75 degree, preferably >10 degree and ≦75 degree. In one embodiment, the O-plate film as shown in FIG. 2A can be disposed on the cholesteric liquid crystal film, and the optical axes of the molecules near the cholesteric liquid crystal film can be substantially in a horizontal or vertical state. FIGS. 3A and 3B are embodiments of the optical component with one O-plate film disposed on the cholesteric liquid crystal film according to the invention. As shown in FIG. 3A, near the cholesteric liquid crystal film 220, optical axis 204 of an exemplified molecule of the O-plate film 210 is substantially in a horizontal state. Alternatively, as shown in FIG. 3B, near the cholesteric liquid crystal film 220, optical axis 205 of an exemplified molecule of the O-plate film 210 is substantially in a vertical state.

Meanwhile, in another embodiment, a retardation plate may include more than one O-plate films and, when combined with the cholesteric liquid crystal film, can form a low-color-shift optical film. O-plate films can be stacked symmetrically or asymmetrically in view of the arrangement of their optical axes. FIGS. 3C to 3J show possible various embodiments of stacking two O-plate films. Each stack in FIGS. 3C, 3F, 3G and 3J is symmetrical for each stack has two O-plate films with splay patterns symmetrical to each other with respect to a virtual line. Each stack in FIGS. 3D, 3E, 3H and 3I is asymmetrical. Although stacks of only two O-plate films are illustrated in FIGS. 3C to 3J, one skilled in the art should appreciate that more than two O-plate films can be used to form the optical component of the invention, by stacking symmetrically or asymmetrically.

The retardation plate according to embodiments of the invention can consist of one or more O-plate films for polarization transformation of the circular polarized light passing through the cholesteric liquid crystal film. In addition, the retardation plate also has function of color shift compensation. Accordingly, embodiments of the invention only need one type of optical film to achieve both functions of polarization transformation and color shift compensation. However, to achieve the same two functions, prior art needs two corresponding optical films, including a quarter wave film (for polarization transformation) and a C-plate compensation film (for color shift compensation). Therefore, the optical component of the invention can simplify display materials and achieve lower cost.

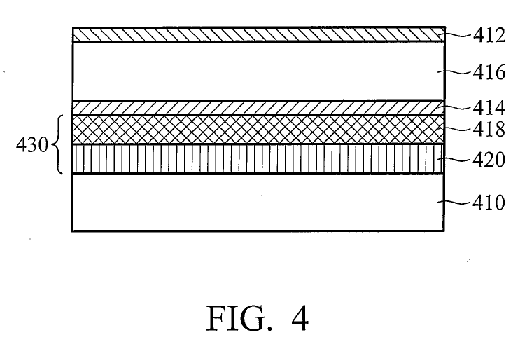

The low color shift optical film of the invention can be used in a liquid crystal display. In an embodiment of the invention, a cross section of the liquid crystal display is as shown in FIG. 4, wherein a pair of top and bottom polarizers 412 and 414 are disposed oppositely to sandwich a liquid crystal cell 416. The liquid crystal cell 416 comprises a color filter substrate and an array substrate sandwiching a liquid crystal layer (not shown). The optical component 430 of the invention is disposed between the bottom polarizer 414 and a backlight source 410. The optical component 430 comprises a quarter wave film 418 consisting of one or more O-plate films disposed on a cholesteric liquid crystal film 420. The combination of the quarter wave film 418, the cholesteric liquid crystal film 420 and the backlight source 410 can provide a low-color-shift polarized light source. The low color shift optical film of the invention combined with a backlight module can enhance the utilization of light energy of the liquid crystal display, such that the requirement of high brightness is achieved.

For application of liquid crystal displays at specific viewing angles, the quarter wave film consisting of a single O-plate film or a plurality of O-plate films with asymmetrical stacking of optical axes is employed for color shift compensation at specific viewing angles. For requirement of liquid crystal displays being viewed at symmetric viewing angles, for example, a large size LCD-TV, the quarter wave film consisting of a plurality of O-plate films symmetrically stacked is preferred to be employed for it can provide more symmetrical optical compensation. Meanwhile, either symmetrical or asymmetrical stack can achieve the same effect of optical compensation.

The optical component of the invention uses one single optical film to provide both the function of polarization transformation of a retardation plate and the function of reducing color shift at larger viewing angles, such that there is no need to combine a quarter wave film with a C-plate compensation film as required in conventional liquid crystal displays. When the optical component of the invention is used in liquid crystal displays, simpler structural materials, lower costs, lower color shift at all viewing angles and higher brightness for the displays are achieved.

### EXAMPLE 1

An O-plate film produced by Far Eastern Textile Inc. is a single plate with in-plane retardation Ro of 60±5 nm, out-of-plane retardation Rth of 94±5 nm, and an optical axes tilt angle of 19.6°. By the stacking shown in FIG. 3C, two of the O-plate films combined to form a quarter wave film, which was then disposed on a broad band cholesteric liquid crystal film to form a low color shift optical film.

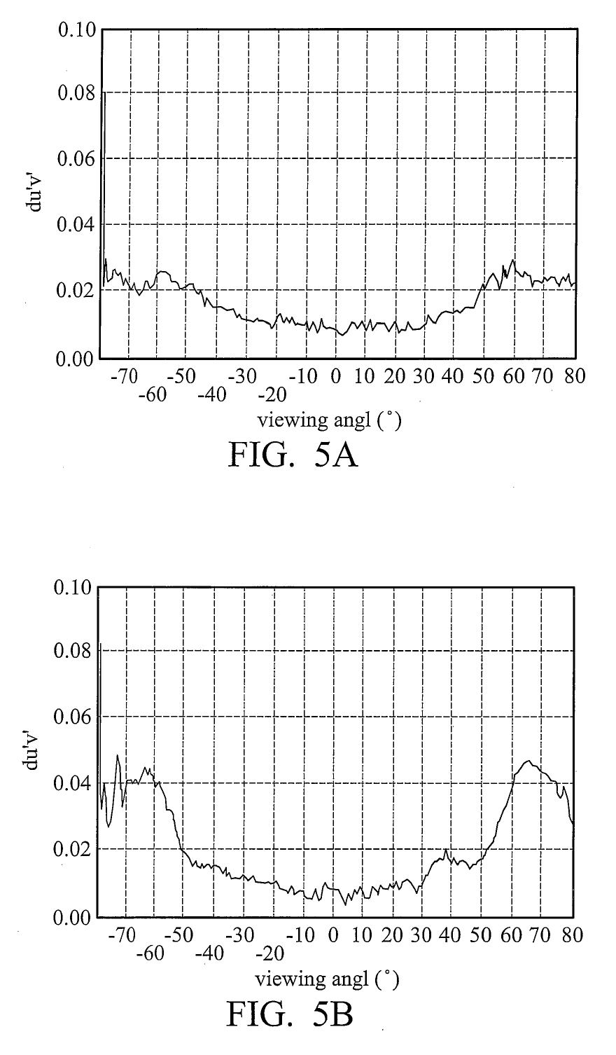

The optical performance of the resulted low color shift optical film was measured by an optical instrument Ezcontrast-160 (product of French Eldim Inc.) to obtain color shift of light emitting at all viewing angles, the color shift being caused by equipping a backlight module under the resulted low color shift optical film. The measurement result of the color shift is shown as in FIG. 5A, wherein the horizontal axis of the diagram is the viewing angles from −80° to +80° and the vertical axis of the diagram is the difference of chromaticity coordinates du′v′, i.e., color shift value. As shown in FIG. 5A, using the optical component of the invention, du′v′ at small viewing angles ≦±40° is about 0.01 or below 0.01, and du′v′ when at large viewing angles (≦±50°) is about 0.02.

### COMPARATIVE EXAMPLE 1

A quarter wave film (product of TEIJIN Chemical Inc., Japan) with an in-plane retardation Ro of 147 nm (@589 nm), an out-of-plane retardation Rth of 75±5 nm and an optical axis tilt angle of 0° was disposed on the broadband cholesteric liquid crystal film to form an optical component. The optical performance of the optical component was measured by an optical instrument Ezcontrast-160 (product of French Eldim Inc.) to obtain color shift of light emitting at all viewing angles after and before a backlight module of a liquid crystal display was assembled. The measurement result of color shift is shown as in FIG. 5B, wherein the horizontal axis of the diagram is the viewing angles from −80° to +80° and the vertical axis of the diagram is the difference of chromaticity coordinates du′v′, i.e., color shift value. As shown in FIG. 5B, using the optical component of Comparative Example 1, du′v′ at small viewing angles ≦±40° is about 0.01, and du′v′ at large viewing angles ≧±50° is about 0.04.

Comparing FIGS. 5A and 5B, although the quarter wave film combined with the broadband cholesteric liquid crystal film of Comparative Example 1 can achieve substantially the same du′v′ of 0.01 as the optical component of the invention at small viewing angles, du′v′ of the optical component of Comparative Example 1 at large viewing angles is about 0.04, greater than du′v′ of the optical component of this invention of 0.02 when at large viewing angles. Accordingly, the optical component of the invention can achieve the requirement of liquid crystal displays for lower color shift at large viewing angles when compared to the conventional quarter wave film combined with the broadband cholesteric liquid crystal film.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A low color shift optical film, comprising:
a cholesteric liquid crystal film; and
a retardation plate consisting of one or more pieces of O-plate type films on the cholesteric liquid crystal film, and
the retardation plate provides functions of polarization transformation and color shift compensation.

2. The low color shift optical film as claimed in claim 1, wherein the retardation plate has an in-plane retardation Ro of 130±30 nm and an out-of-plane retardation Rth greater than 90 nm.

3. The low color shift optical film as claimed in claim 1, wherein at least one O-plate type film of the retardation plate has an average tilted optical axis at an angle >5 degree and ≦75 degree

4. The low color shift optical film as claimed in claim 3, wherein optical axes of the one or more O-plate type films are tilted in a synclinic state or at a fixed angle with respect to the film plane of the O-plate film.

5. The low color shift optical film as claimed in claim 3, wherein optical axes of the one or more O-plate type film are tilted in splay state and the angle between each optical axis and the film plane of the O-plate film is continuously changed

6. The low color shift optical film as claimed in claim 1, wherein at least one O-plate type film of the retardation plate has an average tilted optical axis at an angle >10 degree.

7. The low color shift optical film as claimed in claim 6, wherein optical axes of the O-plate type film are tilted in a synclinic state or at a fixed angle with respect to the film plane of the O-plate film.

8. The low color shift optical film as claimed in claim 6, wherein optical axes of the one or more O-plate type film are tilted in splay state.

9. The low color shift optical film as claimed in claim 1, wherein the retardation plate comprises two O-plate films.

10. The low color shift optical film as claimed in claim 9, wherein the two O-plate films are stacked that optical axes of respective O-plate film films are symmetric.

11. The low color shift optical film as claimed in claim 9, wherein the two O-plate films are so stacked that optical axes of respective O-plate film films are asymmetric.

12. A liquid crystal display, comprising:
a liquid crystal cell;
a pair of top and bottom polarizers oppositely disposed to sandwich the liquid crystal cell;
a backlight source under the liquid crystal cell and the bottom polarizer; and
the low color shift optical film as claimed in claim 1 between the backlight source and the bottom polarizer, wherein the cholesteric liquid crystal film faces the backlight source.

13. The liquid crystal display as claimed in claim 12, wherein no C-plate compensation object is disposed between the O-plate film and the bottom polarizer.

14. A low color shift polarized light source, comprising:
a backlight module; and
the low color shift optical film as claimed in claim 1 over the backlight module.

15. A method for polarization transformation and color shift compensation for a liquid crystal display, comprising:
providing a liquid crystal cell;
providing a pair of top and bottom polarizers oppositely disposed to sandwich the liquid crystal cell;
providing a backlight source under the liquid crystal cell and the bottom polarizer; and
providing the low color shift optical film as claimed in claim 1 between the backlight source and the bottom polarizer, wherein the cholesteric liquid crystal film faces the backlight source.

16. The method as claimed in claim 15, wherein a combination of the backlight source and the low color shift optical film provides a low color shift polarized light source.
